(19) United States
(12) Patent Application Publication
(10) Pub. No.: US 2010/0055268 A1
(43) Pub. Date: Mar. 4, 2010

(54) ACIDIFIED FOOD METHODS AND COMPOSITIONS

(76) Inventor: Richard S. Meyer, Federal Way, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/439,151

(22) PCT Filed: Aug. 27, 2007
(86) PCT No.: PCT/US07/18885

§ 371 Date: Sep. 1, 2009

Related U.S. Application Data
(60) Provisional application No. 60/840,793, filed on Aug. 28, 2006.

(30) Foreign Application Priority Data
Jul. 19, 2007 (US) 11780302

(51) Int. Cl. A23L 3/00; A23L 1/212; A23L 1/216; A23L 1/36; A23L 1/315; A23L 1/31; A23L 1/325

(52) U.S. Cl. 426/326; 426/615; 426/637; 426/629; 426/641; 426/643; 426/644

(57) ABSTRACT

A shelf-stable acidified food product having an edible food and two or more acidulants with sufficient acid to achieve a pH below 4.6. The two or more acidulants are admixed with the edible food in an amount effective to adjust the pH of the food product to the range of 3.8 to 4.5. In some embodiments, the two or more acidulants comprises gluconic acid and sodium acid sulfate.

### CROSS-REFERENCE TO RELATED APPLICATION

This application claims the benefit under 35 U.S.C. §119(e) of U.S. Provisional Patent Application No. 60/840,793 filed Aug. 28, 2006; where this provisional application is incorporated herein by reference in its entirety.

### BACKGROUND

1. Technical Field

The present disclosure is related to the fields of food or edible materials and, more particular, to acidified food compositions and methods for making them.

2. Description of the Related Art

A large variety of food products are formulated at a pH of 4.7 or above. For example, the pH of products such as non-dairy based products like vegetables, main meal entrees, soups, pastas, rice, chowders, meats, and chocolate beverages typically ranges from 6.2 to 6.8.

Main meal entrees (e.g., macaroni and cheese and chicken dinners), soups (e.g., vegetable and chicken noodle soups), beverages (e.g., chocolate milk and mocha frappaccino), creamy salad dressings (e.g., blue cheese and ranch), dips (e.g., ranch and French onion), vegetables (e.g., potatoes, carrots, green beans, and peas), chowders (e.g., clam chowder and ham chowder), side dishes (e.g., rice bowls, sauces, and noodles), and sauces normally require refrigeration, freezing, or retorting to preserve shelf stability. Both retorting (6 minutes at 250° F.) and freezing (days to months at minus 20° F.) results in an 80% to 93% loss in texture in vegetables compared to fresh vegetables, while hot filling results in a loss of about 30%. There is also a substantial energy savings of approximately 70% to 95% going from retorting or freezing to hot filling.

Adding acidulants may prolong the shelf life of a product. Typical acidulants, however, contribute an undesirable acid taste to the products.

Commercial acceptance of many food products is dependent on a variety of factors, such as cost to manufacture, shelf life, stability during storage, taste, ease-of-preparation, or disposal issues, or combinations thereof. Therefore, it may be desirable to have novel shelf-stable products that do not require refrigeration, freezing, retorting, or dehydration.

The present disclosure is directed to overcome one or more of the shortcomings set forth above, and provide further related advantages.

### BRIEF SUMMARY

In one aspect, the present disclosure is directed to a shelf-stable food composition including at least one food material, a first acidulant, and a second acidulant. The at least one food material is selected from a tuber, a vegetable, a root vegetable, a legume, a nut, a grain, or an animal product. In some embodiments, the ratio of the first acidulant to the second acidulant is greater than about 1. In some embodiments, the shelf-stable food composition comprises an average pH that ranges from about 3.8 to about 4.5. In some embodiments, the ratio of the first acidulant to the second acidulant ranges from about 1 to about 10. In some embodiments, the first acidulant comprises gluconic acid, and the second acidulant comprises sodium acid sulfate. In some embodiments, the first acidulant comprises gluconic acid, and the second acidulant comprises malic acid.

In another aspect, the present disclosure is directed to a shelf-stable food composition. In some embodiments, the shelf-stable food composition includes at least one food material, two or more acidulants, and one or more flavor enhancers. In some embodiments, the food material is selected from a tuber, a vegetable, a root vegetable, a legume, a nut, a grain, or an animal product. In some embodiments, the shelf-stable food composition comprises a pH ranging from about 3.8 to about 4.5.

In another aspect, the present disclosure is directed to a method for making a shelf-stable food product. The method includes providing a food product including a food material selected from a tuber, a vegetable, a root vegetable, a legume, a nut, a grain, or an animal product, or combinations thereof. The method further includes acidifying the food product with gluconic acid and sodium acid sulfate. In some embodiments, the method may further include providing one or more flavor enhancers and a food additive.

### DETAILED DESCRIPTION

In the following description, certain specific details are included to provide a thorough understanding of various disclosed embodiments. One skilled in the relevant art, however, will recognize that embodiments may be practiced without one or more of these specific details, or with other methods, components, materials, etc. In other instances, well-known additives or ingredients associated with food composition including but not limited to salts, preservatives, flavor enhancers, and the like have not been described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” or “an embodiment,” or “in another embodiment” means that a particular referent feature, structure, or characteristic described in connection with the embodiment is included in at least one embodiment. Thus, the appearance of the phrases “in one embodiment,” or “in an embodiment,” or “in another embodiment” in various places throughout this specification are not necessarily all referring to the same embodiment. Furthermore, the particular features, structures, or characteristics may be combined in any suitable manner in one or more embodiments.

It should be noted that, as used in this specification and the appended claims, the singular forms “a,” “an,” and “the” include plural referents unless the context clearly dictates otherwise. Thus, for example, reference to a food composition including “an acidulant” includes a single acidulant, or two or more acidulants. It should also be noted that the term “or” is generally employed in its sense including “and/or” unless the content clearly dictates otherwise.

In some embodiments, the present disclosure provides a shelf-stable food composition product that does not require refrigeration, freezing, retorting, dehydration, or other meads of prolonging the shelf stability. The shelf-stable food composition includes at least one food material selected from a tuber, a vegetable, a root vegetable, a legume, a nut, a grain, or an animal product, as well as natural or synthetic additives.

In some embodiments, the at least one food material is a tuber such as, for example, a stem tuber (e.g., potatoes and the like), a root tuber (e.g., sweet potatoes, taro, and the like), and the like. In some embodiments, the tuber is a potato (e.g., mashed potato, dehydrated potato, cooked or uncooked potato, and the like). In some embodiments, the at least one food material is a vegetable. In some embodiments, the at least one food material comprises at least one vegetable and at least one grain. In some embodiments, the at least one food material is an animal product selected from mammals, fowl, fish, crustaceans, and mollusks.

The shelf-stable food composition may further include two or more acidulants (also referred to as acidifying agents). Among the acidulants examples include gluconic acid (which can be derived from Glucono-delta lactone), acetic, adipic, ascorbic, citric, sorbic, erythorbic, hydrochloric acids, lactic, malic, phosphoric, sodium acid sulfate, sulfuric, tartaric, and the like, or combinations or mixtures thereof. Further examples of acidulants include acid salt selected from the group consisting of sodium and potassium salts of phosphoric, sulfuric, hydrochloric acids, and the like or combinations or mixtures thereof. Acidulants can contribute to flavor and assist in the preservation of foods and beverages by acting as chelators. Acidulants may also optimize the preservative effect of benzoate and sorbate (e.g., sorbate salts, potassium sorbate, calcium sorbate, and the like), which are most effective at a pH below 4.5. In some embodiments, the shelf-stable food composition comprises an effective amount of a first acidulant and a second acidulant to render the food product shelf stable at or above about 40° F. for more than 2 days. In some embodiments, the shelf-stable food composition comprises an effective amount of a first acidulant and a second acidulant to render the food product shelf stable at or above about 40° F. for more than 2 years. In some embodiments, the ratio of first acidulant to second acidulant is greater than about 1. In some further embodiments, the ratio of first acidulant to second acidulant ranges from about 1 to about 10.

For example, in some embodiments, the shelf-stable food composition comprises an effective amount of gluconic acid and sodium acid sulfate to render the food product shelf stable at or above about 40° F. for more than 2 days. In some embodiments, the shelf-stable food composition comprises an effective amount of gluconic acid and sodium acid sulfate to render the food product shelf stable at or above about 40° F. for more than 2 years. In some embodiments, the ratio of gluconic acid to sodium acid sulfate is greater than about 1. In some further embodiments, the ratio of gluconic acid to sodium acid sulfate ranges from about 1 to about 10.

In some embodiments, the ratio of gluconic acid to sodium acid sulfate is greater than about 1, and the pH of the shelf-stable food composition ranges from about 3.8 to about 4.5.

In some embodiments, the shelf-stable food composition comprises a pH ranging from about 3.8 to about 4.5. In some embodiments, a food product is produced by acidifying the food composition to a pH range of from about 3.8 to about 4.5 using a unique blend of acidulants. The unique blend of acidulants may include mixtures of at least a first acidulant and a second acidulant. In some embodiments, the unique blend of acidulants may include mixtures of gluconic acid and sodium acid sulfate.

The shelf-stable food composition may further include one or more flavor enhancers. As used herein the term “flavor enhancer” generally refers to a substance, compound, or additive that may supplement, enhance, or modify the original taste or aroma of a food. Among flavor enhancers examples include, without limitation, Calcium 5′-ribonucleotides, Calcium diglutamate, Calcium guanylate, Calcium inosinate, Dipotassium guanylate, Dipotassium inosinate, Disodium 5′-ribonucleotides, Disodium guanylate, sodium guanylate, Disodium inosinate, Ethyl maltol, Glutamic acid, Glycine and its sodium salt, Guanylic acid, Inosinic acid, Magnesium diglutamate, Maltol, Monoammonium glutamate, Monopotassium glutamate, Monosodium glutamate, and the like. Further examples of flavor enhancers include yeast extracts sold under the trade name of MAXAROME® Standard, MAXAROME® Plus, MAXAROME® Premium, MAXAROME® Select, starter distillates, and the like. In some embodiments, at least one of the one or more flavor enhancers is selected from starter distillates, yeast extracts, gluco-delta-lactone, sodium acid sulfate, sugar, inosinate, guanylate, onion powder, garlic powder, white pepper, malic acid, and sodium chlorate. In some embodiments, the one or more flavor enhancers are selected from disodium inosinate and disodium guanylate.

The present disclosure is also applicable to the production of shelf-stable vegetables such as potatoes, green beans, broccoli, leafy herbs, sweet corn, peas, carrots, asparagus, rice, and the like, or combinations thereof. Some food products require refrigeration to preserve shelf stability. Typically, refrigerating food products at or below 40° F. slows down bacterial (e.g., clostridium botulinum, and the like) growth or reproduction. Freezing foods at or below 0° F. may stop most bacterial growth or reproduction.

In some embodiments, the present disclosure provides a method for increasing shelf stability of a food product. The method includes providing a food product comprising a food material selected from a tuber, a vegetable, a root vegetable, a legume, a nut, a grain, or an animal product, or combinations thereof.

The method further includes acidifying the food product with a mixture comprising a first acidulant and a second acidulant different than the first. In some embodiments, the first acidulant is gluconic acid and the second acidulant is sodium acid sulfate.

In some embodiments, acidifying the food product comprises providing an effective amount of the first and second acidulants to acidify the food product to a pH ranging from about 3.8 to about 4.5. In some embodiments, acidifying the food product comprises providing an effective amount of gluconic acid and sodium acid sulfate to acidify the food product to a pH ranging from about 3.8 to about 4.5. In other embodiments, acidifying the food product comprises providing an effective amount of a mixture of gluconic acid and sodium to allow a food product to be made shelf stable which previously could only be stored refrigerated or frozen. In some embodiments the shelf life is prolonged by inhibiting, or substantially preventing microbial growth or reproduction (e.g., yeast, mold, or bacteria growth or reproduction) with or without refrigeration or freezing.

The resulting acidified food product may be shelf stable for a period greater than about several years. In some embodiments, the resulting acidified food product may be shelf stable from a period ranging from about a few days to about 24 months or longer. In the case of potatoes, the resulting acidified food product may be shelf stable from a period greater than one month to greater than about 24 months.

In some embodiments, providing an effective amount of the mixture of gluconic acid and sodium comprises providing gluconic acid and sodium acid sulfate in a ratio greater than about 1. In some embodiments, the ratio of gluconic acid to sodium acid sulfate is greater than about 1, and the pH of the shelf-stable food composition ranges from about 3.8 to about 4.5. In yet some other embodiments, acidifying the food product comprises infusing the food product with a mixture of gluconic acid and sodium acid sulfate.

The method may further include providing at least one of a flavor enhancer or a food additive

In the case of non-mashed products (e.g., non-mashed vegetables, meats, and the like), for example, the non-mashed products are infused with a blend of the acidifying agents. In some embodiments, a vacuum (23 to 24 inches Hg) is then pulled on the infused non-mashed products to infuse the acid blend thoroughly throughout the product. The process not only acidifies the products, but may also render them shelf-stable and, in some cases, impart a salty flavor. In some embodiments the process may employ a gentle, low heat process.

In some embodiments, a continuous vacuum can be achieved by pumping the food product in the fluid acidifying solution through a tube which rises vertically about 24 feet then comes straight down. At the peak of the 24-foot tube, there is a vacuum outlet to remove the air which comes from the vegetables and which is replaced with the acidifying solution.

The method may further include hot-filling a container with the acidified food product. The method may further include sealing the hot-filled container. In some embodiments sealing the hot-filled container comprises vacuum sealing the hot-filled container.

The method may further include pasteurizing the acidified food product.

The method may further include mixing the acidified food product to obtain a substantially homogenous mixture of the food product and the mixture of gluconic acid and sodium acid sulfate.

The disclosed methods and processes may be applicable to other food products such as, for example, fowl (e.g., duck, chicken, turkey, and the like) seafood (e.g., fish, mollusk, crustaceans, and the like), pork, beef, other red meats, and the like. If meats are acidified in accordance with some embodiments of the present disclosure, they can be gently pasteurized without destroying texture, flavor, or appearance.

In examples 1 through 11 below, dehydrated potatoes were combined with water, sodium chloride, butter (unsalted), milk, heavy cream, as well as other flavorants and additives. The flavor enhancers included starter distillates (e.g., DairiChem 15X starter culture), which provides a butter flavor, diacetyl natural butter flavor, yeast extracts (e.g., DSM brand Maxarone Plus yeast extract that provides a slight cheese flavor and masks the acid flavor, Savoury Systems brand HPP #243 that imparts a mild chicken broth flavor, and the like), and acidifying agents (e.g., gluco-delta-lactone, sodium acid sulfate, and the like). Other additives included potassium chloride, sugar, inosinate/guanylate, onion powder, garlic powder, white pepper, and malic acid. The quantities of each of the ingredients in the example tables are listed in grams and in percentage of total weight. A general preparation procedure included weighing the ingredients, and heating the water, butter, salt, and milk in a sauce pan. The heavy cream was separately weighed and combined with the starter cultures and the diacetyl butter flavor and then set aside. The dehydrated potato granules were then weighed and set aside. The remaining dry ingredients were weighed and blended together. The water blend was then heated to a boil. The heavy cream was added in and blended and removed from the heat. While stirring, the liquid dehydrated potato granules were added. When the potato granules were thoroughly wetted, the mixture was allowed to sit for five minutes and then stirred again. The mixture was then reheated to 160° F. and held for three minutes to pasteurize it. The mixture was then hot-filled into sterilized plastic pouches. The pouches were vacuum sealed and allowed to cool.

The pouches were allowed to stand for a period of ten days without any noticeable deterioration. After ten days, they have the flavors indicated in the attached table. Where indicated, the food product was tasted by six trained sensory panelists (trained to detect off flavors). The sensory protocol included comparing the taste of the acidified product against competing samples and an unacidified control. The object was to have a food product with either no flavor difference, or minimal flavor difference, or an acceptable flavor difference between the acidified product and the unacidified control. An acceptable difference generally refers to the case where the acidified product tastes better than the unacidified control.

The following examples provide non-limiting embodiments of various combinations of methods and compositions.

### Example 1

### Acidified Mashed Potatoes

| | | | batch size |
|---|---|---|---|
| | wt | wt % | 1000.000 |
| dehydrated potatoes | 16.410 | 16.577% | 165.774 |
| water | 44.260 | 44.712% | 447.116 |
| salt | 0.300 | 0.303% | 3.031 |
| butter, no salt | 16.000 | 16.163% | 161.632 |
| milk | 21.000 | 21.214% | 212.143 |
| Gluconic acid | 0.400 | 0.404% | 4.041 |
| Sodium acid sulfate | 0.040 | 0.040% | 0.404 |
| di-Sodium Inosinate/Guanylate | 0.010 | 0.010% | 0.101 |
| Savoury Systems hydrolyzed | 0.300 | 0.303% | 3.031 |
| vegetable protein # 243 | | | |
| onion powder | 0.200 | 0.202% | 2.020 |
| garlic powder | 0.050 | 0.051% | 0.505 |
| white pepper | 0.020 | 0.020% | 0.202 |
| | 98.990 | 100.000% | 1000.000 |
| Final pH: 4.47 | | | |

Processing procedures:

1. Weigh together water, butter, salt, and place in a sauce pan to heat.

2. Weigh separately the heavy cream and set aside.

3. Weigh the dehydrate potato granules and set aside.

4. Weigh and blend together the remaining dry ingredients.

5. Heat the water blend from #1 to a boil, add the heavy cream blend and remove from heat. While stirring, add the dehydrated potato granules.

6. When potato granules are thoroughly wetted, let stand for 5 minutes and stir again. Reheat to 95° C., hold for 3 minutes; hot fill into plastic pouches

7. Vacuum seal the hot pouches and cool.

8. Alternative processing: in step 6, do not reheat to 95° C., but fill (about 70° C.) and vacuum seal in pouches.

9. Place pouches in a high pressure vessel; pressurize to 600 MPa and hold for 3 minutes and release pressure.

### Examples 2-10

Examples 2 through 10 were prepared using the following procedure:

1. Weigh together water, butter, and salt and place in a sauce pan to heat.

2. Weigh separately the heavy cream, DainChem starter distillate and the diacetyl and set aside.

3. Weigh the dehydrate potato granules and set aside.

4. Weigh and blend together the remaining dry ingredients.

5. Heat the water blend from #1 to a boil, add the heavy cream blend and remove from heat. While stirring, add the dehydrated potato granules.

6. When potato granules are thoroughly wetted, let stand for 5 minutes and stir again. Reheat to 160° F., hold for 3 minutes; hot fill into plastic pouches.

7. Vacuum seal the hot pouches and cool.

### Example 2

### Acidified Mashed Potatoes

| | | | | batch |
|---|---|---|---|---|
| | | | | size |
| cups | | wt | wt % | 1000.00 |
| 1⅓ | dehydrated potatoes | 86.00 | 16.404% | 164.04 |
| 1⅓ | water | 273.00 | 52.072% | 520.72 |
| ½ | salt | 0.00 | 0.000% | 0.00 |
| teas. | | | | |
| 2 T | butter, no salt | 45.00 | 8.583% | 85.83 |
| ½ | milk | | 0.000% | 0.00 |
| ½ | Heavy cream | 112.00 | 21.363% | 213.63 |
| | DainChem 15 X starter | 0.50 | 0.095% | 0.95 |
| | culture | | | |
| | diacetyl natural butter flavor | 0.00 | 0.000% | 0.00 |
| | DSM Maxarone Plus 5070 | | | |
| | yeast extract | | | |
| | Gluco-delta-lactone | 2.10 | 0.401% | 4.01 |
| | Sodium acid sulfate | 1.40 | 0.267% | 2.67 |
| | Potassium chloride | 0.00 | 0.000% | 0.00 |
| | sugar | 4.00 | 0.763% | 7.63 |
| | Inosinate/Guanylate | 0.05 | 0.010% | 0.10 |
| Savoury | HPP #243 | 0.10 | 0.019% | 0.19 |
| | onion powder | 0.10 | 0.019% | 0.19 |
| | garlic powder | 0.02 | 0.004% | 0.04 |
| | white pepper | | | |
| | malic acid | | | |
| | | 524.27 | 100.000% | 1000.00 |

### Example 3

### Acidified Mashed Potatoes

| | | | | batch |
|---|---|---|---|---|
| | | | | size |
| cups | | wt | wt % | 1000.00 |
| 1⅓ | dehydrated potatoes | 16.410 | 16.410% | 164.100 |
| 1⅓ | water | 44.260 | 44.260% | 424.600 |
| ½ | salt | 0.300 | 0.300% | 3.000 |
| teas. | | | | |
| 2 T | butter, no salt | 16.000 | 16.000% | 160.000 |
| ½ | milk | 21.000 | 21.000% | 210.000 |
| ½ | Heavy cream | | | |
| | DainChem 15 X starter | 0.600 | 0.600% | 6.000 |
| | culture | | | |
| | diacetyl natural butter flavor | 0.050 | 0.050% | 0.500 |
| | DSM Maxarone Plus 5070 | | | |
| | yeast extract | | | |
| | Gluco-delta-lactone | 0.800 | 0.800% | 8.000 |
| | Sodium acid sulfate | | | |
| | Potassium chloride | | | |
| | sugar | | | |
| | Inosinate/Guanylate | 0.010 | 0.010% | 0.100 |
| Savoury | HPP #243 | 0.300 | 0.300% | 3.000 |
| | onion powder | 0.200 | 0.200% | 2.000 |
| | garlic powder | 0.050 | 0.050% | 0.500 |
| | white pepper | 0.020 | 0.020% | 0.200 |
| | malic acid | | | |
| | | 100.000 | 100.000% | 1000.000 |
| | Final pH: 4.47 | | | |

Good flavor

### Example 4

### Acidified Mashed Potatoes

| cups | | wt |
|---|---|---|
| 1⅓ | dehydrated potatoes | 16.410 |
| 1⅓ | water | 54.260 |
| ½ teas. | salt | 0.300 |
| 2 T | butter, no salt | 16.000 |
| ½ | milk | 21.000 |
| ½ | Heavy cream | |
| | DainChem 15 X starter culture | 0.600 |
| | diacetyl natural butter flavor | 0.050 |
| | DSM Maxarone Plus 5070 yeast extract | |
| | Gluco-delta-lactone | 0.800 |
| | Sodium acid sulfate | |
| | Potassium chloride | |
| | sugar | |
| | Inosinate/Guanylate | 0.010 |
| Savoury | HPP #243 | 0.300 |
| | onion powder | 0.200 |
| | garlic powder | 0.050 |
| | white pepper | 0.120 |
| | matic acid | |
| | Final pH: 4.24 | 4.24 |

Good flavor

### Example 5

### Acidified Mashed Potatoes

| cups | | wt |
|---|---|---|
| 1⅓ | dehydrated potatoes | 16.410 |
| 1⅓ | water | 64.260 |
| ½ teas. | salt | 0.300 |
| 2 T | butter, no salt | 16.000 |
| ½ | milk | 21.000 |
| ½ | Heavy cream | |
| | DainChem 15 X starter culture | 0.600 |
| | diacetyl natural butter flavor | 0.050 |
| | DSM Maxarone Plus 5070 yeast extract | |
| | Gluco-delta-lactone | 0.800 |
| | Sodium acid sulfate | 0.100 |
| | Potassium chloride | |
| | sugar | |
| | Inosinate/Guanylate | 0.010 |
| Savoury | HPP #243 | 0.300 |
| | onion powder | 0.200 |
| | garlic powder | 0.050 |
| | white pepper | 0.020 |
| | malic acid | |
| | | 120.10 |
| | Final pH: 4.20 | |

Very good flavor

### Example 6

### Acidified Mashed Potatoes

| | | | batch |
|---|---|---|---|
| | | | size |
| cups | | wt % | 1000.000 |
| 1⅓ | dehydrated potatoes | 13.664% | 136.636 |
| 1⅓ | water | 53.505% | 535.054 |
| ½ teas. | salt | 0.250% | 2.498 |
| 2 T | butter, no salt | 13.322% | 13.222 |
| ½ | milk | 17.485% | 1.7485 |
| ½ | Heavy cream | | |
| | DainChem 15 X starter culture | 0.500% | 4.996 |
| | diacetyl natural butter flavor | 0.042% | 0.416 |
| | DSM Maxarone Plus 5070 yeast | | |
| | extract | | |
| | Gluco-delta-lactone | 0.666% | 6.661 |
| | Sodium acid sulfate | 0.083% | 0.833 |
| | Potassium chloride | | |
| | sugar | | |
| | Inosinate/Guanylate | 0.008% | 0.083 |
| Savoury | HPP #243 | 0.250% | 2.498 |
| | onion powder | 0.167% | 1.665 |
| | garlic powder | 0.042% | 0.416 |
| | white pepper | 0.017% | 0.167 |
| | malic acid | | |
| | | 100.000% | 1000.000 |

### Example 7

### Acidified Mashed Potatoes

| | | BEST | |
|---|---|---|---|
| cups | | wt | wt % |
| 1⅓ | dehydrated potatoes | 16.410 | 13.650% |
| 1⅓ | water | 64.260 | 53.452% |
| ½ teas. | salt | 0.300 | 0.250% |
| 2 T | butter, no salt | 16.000 | 13.309% |
| ½ | milk | 21.000 | 17.468% |
| ½ | Heavy cream | | 0.000% |
| | DainChem 15 X starter culture | 0.600 | 0.499% |
| | diacetyl nat. butter flavor | 0.050 | 0.042% |
| | DSM Maxarone Plus 5070 yeast | 0.120 | 0.100% |
| | extract | | |
| | Gluco-delta-lactone | 0.800 | 0.665% |
| | Sodium acid sulfate | 0.100 | 0.083% |
| | Potassium chloride | | 0.000% |
| | sugar | | 0.000% |
| | Inosinate/Guanylate | 0.010 | 0.008% |
| Savoury | HPP #243 | 0.300 | 0.250% |
| | onion powder | 0.200 | 0.166% |
| | garlic powder | 0.050 | 0.042% |
| | white pepper | 0.020 | 0.017% |
| | malic acid | | |
| | | 120.220 | 100.000% |
| | Final pH: 4.2 | | |

Example 7 was determined to be best overall in flavor using the previously described sensory protocol.

### Example 8

### Acidified Mashed Potatoes

| | |
|---|---|
| Example 6 Base | 100 |
| HPP #243 | 0.25 |
| DSM Maxarone Plus | — |
| 5070 Yeast Extract | |

### Example 9

### Acidified Mashed Potatoes

| | |
|---|---|
| Example 6 Base | 100 |
| HPP #243 | — |
| DSM Maxarone Plus | 0.1 |
| 5070 Yeast Extract | |

Best

### Example 10

### Acidified Mashed Potatoes

| | |
|---|---|
| Example 6 Base | 100 |
| HPP #243 | 0.25 |
| DSM Maxarone Plus | 0.1 |
| 5070 Yeast Extract | |

### Example 11

### Acidified Mashed Potatoes

### Version GA1 Base

Example 11 was prepared using the following procedure:

1. Peel fresh potatoes and cut into 1 inch dices; place in boiling, 0.7% salted, water and cook for 20 minutes (until tender).

2. Pre-weigh salt, milk, and unsalted butter and set aside.

3. After 20 minutes, drain water form potatoes, add salt, milk, and unsalted butter, and whip until smooth.

4. Hot fill at 192° F. into foil pouch, vacuum seal and hold for 4 minutes in a 192° F. water bath.

BEST

| | wt % | wt |
|---|---|---|
| cooked, fresh potatoes | 76.00 | 760 |
| butter, no salt | 6.20 | 62.00 |
| milk, whole | 16.85 | 168.50 |
| gluconic Acid | 0.85 | 8.50 |
| sodium acid sulfate | 0.10 | 1.00 |
| | 100.00 | 1000.0 |
| Final pH: 4.0 | | |

Very Good

### Examples 12-14

Examples 12-14 were prepared using the following procedures:

1. Pell fresh potatoes and cut into 1 inch dices; place in boiling, 0.7% salted water and cook for 20 minutes (until tender), drain.

2. Add cooked potatoes to a mixer.

3. Weigh and add to the potatoes, the salt, milk, unsalted butter, gluconic acid and sodium acid sulfate.

4. Whip until smooth.

5. Re-heat to 190° F., hold 4.2 minutes and fill using an aseptic filler into pouches and vacuum seal. Chill pouches immediately after filling to below 90° F.

### Example 12

### Acidified Mashed Potatoes

| | wt | wt % |
|---|---|---|
| cooked, fresh potatoes | 76.10 | 74.89% |
| salt | 0.70 | 0.69% |
| butter, no salt | 6.20 | 6.10% |
| milk, whole | 17.00 | 16.73% |
| Gluconic acid | 1.50 | 1.48% |
| Sodium acid sulfate | 0.12 | 0.12% |
| | 101.62 | 100% |
| pH: 4.05 | | |

### Example 13

### Acidified Mashed Potatoes

| | | % |
|---|---|---|
| cooked, fresh potatoes | 760.0 | 74.84% |
| salt | 7.00 | 0.69% |
| butter, no salt | 62.00 | 6.11% |
| milk, whole | 168.50 | 16.59% |
| Gluconic acid | 17.00 | 1.67% |
| Sodium acid sulfate | 1.00 | 0.10% |
| | 1015.50 | 100.00% |
| pH: 4.10 | | |

### Example 14

### Acidified Potatoes

| | | batch |
|---|---|---|
| | potatoes | size |
| | wt % | 1739.2 |
| diced potatoes, | 41.97% | 730.00 |
| ½ inch cubes | | |
| water | 56.06% | 975.00 |
| gluconic acid | 0.60% | 9.75 |
| Sodium acid | 0.06% | 1.20 |
| sulfate | | |

Dry Ingredients

| | | |
|---|---|---|
| sugar | | 5.00 |
| Maltodextrin, 5 | | 10.00 |
| DE | | |
| Maxarome plus | 1.01% | 4.00 |
| 2491 yeast | | |
| extract | | |
| salt | 0.25% | 3.75 |
| inosinate & | 0.10% | 0.5 |
| guanylate | | |
| | 100.00% | 1739.2 |
| pH: 3.9 | | |

### Examples 15 and 16

Examples 15 and 16 were prepared using the following procedures

1. Blend together all dry ingredients.

2. Blend together all wet ingredients including the vegetable and then add the dry ingredients, gently blend.

3. Bring entire mixture to a boil (100° C.), cover and simmer until the vegetables are cooked, but still firm (about 10 minutes for carrots and green beans; about 18 to about 20 minutes for the potato dices and rice).

4. Hot fill into foil pouches (95° C.) and vacuum seal.

5. Chill pouches below 38° C.

Alternative process: Cook vegetables and rice 2 minutes less; fill into foil pouches; vacuum seal and place in a high pressure

vessel (temperature about 70° C.); pressurize to 600 Mpa and hold for 3 minutes.

6. Target pH: from about 4.2 to about 4.5

### Example 15

### Acidified Vegetables

Acidified Vegetables (wt %)

| | Green | | pea | | | |
|---|---|---|---|---|---|---|
| | beans | Carrots | pods | broccoli | potatoes | Rice |
| green beans | 32.67% | | | | | |
| carrots | | 32.67% | | | | |
| pod peas | | | 32.67% | | | |
| broccoli | | | | 32.67% | | |
| diced potatoes, | | | | | 41.97% | |
| ½ inch cubes | | | | | | |
| rice, white, dry | | | | | | 37.34% |
| water | 65.00% | 65.00% | 61.22% | 65.00% | 56.06% | 60.65% |
| gluconic acid | 0.45% | 0.45% | 0.45% | 0.45% | 0.60% | 0.60% |
| (50% solution) | | | | | | |
| Sodium acid | 0.06% | 0.06% | 0.06% | 0.06% | 0.06% | 0.06% |
| sulfate | | | | | | |
| sugar | 1.00% | 1.00% | 5.00% | 1.00% | | |
| DSM Maxarome | 0.47% | 0.47% | 0.25% | 0.47% | 1.01% | 1.00% |
| plus 2491 | | | | | | |
| yeast extract | | | | | | |
| salt | 0.25% | 0.25% | 0.25% | 0.25% | 0.25% | 0.25% |
| di-Sodium | 0.10% | 0.10% | 0.10% | 0.10% | 0.10% | 0.10% |
| inosinate & | | | | | | |
| guanylate | | | | | | |
| | 100.00% | 100.00% | 100.00% | 100.00% | 100.05% | 100.00% |

### Example 16

### Acidified Vegetables

Acidified Vegetables (wt %)

| | Green beans | batch size | Carrots | batch size | | batch size |
|---|---|---|---|---|---|---|
| | % | 500 | % | 500 | potatoes | 500 |
| green beans | 32.67% | 163.35 | | | | |
| carrots | | | 32.67% | 163.35 | | |
| pod peas | | | | | | |
| broccoli | | | | | | |
| diced potatoes, | | | | | 41.97% | |
| ½ inch cubes | | | | | | |
| water | 65.00% | 325.00 | 65.00% | | 56.06% | |
| gluconic acid | 0.65% | 3.25 | 0.45% | | 0.60% | |
| Sodium acid | 0.08% | 0.40 | 0.06% | | 0.06% | |
| sulfate | | | | | | |
| Dry Ingredients | | | | | | |
| sugar | 1.00% | 5.00 | 1.00% | | | |
| Maltodextrin, 5 DE | | | | | | |
| Maxarome plus | 0.25% | 1.25 | 0.47% | | 1.01% | |
| 2491 yeast | | | | | | |
| extract | | | | | | |
| salt | 0.25% | 1.25 | 0.25% | | 0.25% | |
| inosinate & | 0.10% | 0.50 | 0.10% | | 0.10% | |
| guanylate | | | | | | |
| | 100.00% | 500.00 | 100.00% | | 100.05% | |

pH; 3.9

The various embodiments described above can be combined to provide further embodiments. All of the U.S. patents, U.S. patent application publications, U.S. patent applications, foreign patents, foreign patent applications and non-patent publications referred to in this specification or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A shelf-stable food composition, comprising:
at least one food material selected from a tuber, a vegetable, a root vegetable, a legume, a nut, a grain, or an animal product;
a first acidulant; and
a second acidulant different than the first acidulant;
wherein the ratio of the first acidulant to the second acidulant is greater than about 1; and the shelf-stable food composition comprises a pH ranging from about 3.8 to about 4.5.

2. The composition of claim 1 wherein the first acidulants comprises gluconic acid, and the second acidulant comprises sodium acid sulfate.

3. The composition of claim 1 wherein the first acidulant comprises gluconic acid, the second acidulant comprises sodium acid sulfate, and the ratio of the gluconic acid to the sodium acid sulfate ranges from about 1 to about 10.

4. The composition of claim 1 wherein the first acidulant comprises gluconic acid, and the second acidulant comprises sodium acid sulfate, and the ratio of the gluconic acid to the sodium acid sulfate is about 9.

5. The composition of claim 1 wherein the at least one food material is a tuber.

6. The composition of claim 5 wherein the tuber is a potato.

7. The composition of claim 1 wherein the at least one food material is a vegetable.

8. The composition of claim 1 wherein the at least one food material comprises at least one vegetable, and at least one grain.

9. The composition of claim 1, further comprising:
one or more flavor enhancers selected from starter distillates, yeast extracts, gluco-delta-lactone, sodium acid sulfate, sugar, inosinate, guanylate, onion powder, garlic powder, white pepper, malic acid, and sodium chlorate, or combinations thereof.

10. The composition of claim 1, further comprising:
one or more flavor enhancers selected from disodium inosinate and disodium guanylate.

11. The composition of claim 1 wherein the at least one food material is an animal product selected from mammals, fowl, fish, crustaceans, and mollusks.

12. A method for making a shelf stable food product, comprising:
providing a food product comprising:
a food material selected from a tuber, a vegetable, a root vegetable, a legume, a nut, a grain, or an animal product, or combinations thereof,
a flavor enhancer, and
a food additive; and
acidifying the food product with gluconic acid and sodium acid sulfate.

13. The method of claim 12 wherein acidifying the food product comprises providing an effective amount of the gluconic acid and the sodium acid sulfate to acidify the food product to a pH ranging from about 3.8 to about 4.5.

14. The method of claim 12 wherein acidifying the food product comprises providing an effective amount of the gluconic acid and the sodium acid sulfate to render the food product shelf stable at or above about 40° F.

15. The method of claim 12 wherein acidifying the food product comprises infusing the food product with gluconic acid and sodium acid sulfate.

16. The method of claim 12, further comprising:
hot-filling a container with the acidified food product.

17. The method of claim 16, further comprising:
sealing the hot-filled container.

18. The method of claim 17 wherein sealing the hot-filled container comprises vacuum sealing the hot-filled container.

19. The method of claim 18, further comprising:
pasteurizing the acidified food product.

20. The method of claim 12, further comprising:
mixing the acidified food product to obtain a substantially homogenous mixture of the food product and the mixture of gluconic acid and sodium acid sulfate.
